(19) United States
(12) Patent Application Publication
(10) Pub. No.: US 2011/0010140 A1
(43) Pub. Date: Jan. 13, 2011

(54) Probability Distribution Function Mapping Method

(75) Inventors: David H. Hoitsma, Brentwood, NY (US); Stephen J. Engel, East Northport, NY (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Northrop Grumman Corporation, Los Angeles, CA (US)

(21) Appl. No.: 12/501,542

(22) Filed: Jul. 13, 2009

(51) Int. Cl. G06F 17/10

(52) U.S. Cl. 703/2

(57) ABSTRACT

A method includes: receiving a plurality of values of an input variable representative of a physical characteristic of a component or system, using a physics model to produce an estimate of an output for each of the input values, mapping the output estimates to the input values to produce an output probability density or cumulative distribution function for the physical characteristic at a future time, and outputting the probability density or cumulative distribution function. An apparatus that implements the method is also provided.

### STATEMENT OF GOVERNMENT INTEREST

This invention was made under Contract No. DARPA HR001-04-C-003. The United States Government has rights in this invention under the contract.

### FIELD OF THE INVENTION

This invention relates to methods and apparatus for determining probability distribution functions and/or cumulative probability distributions.

### BACKGROUND OF THE INVENTION

Physics-based probabilistic reliability/risk analysis can be used to predict the probabilities of component failure and to schedule maintenance of complex systems. A physics-based analysis uses a physics model to simulate the behavior of systems and components of such systems. Physics models can be computationally complex, requiring a large number of input variables to conduct an accurate analysis of a system (FIG. 1). The prediction of fatigue failure typically involves a model such as FASTRAN (commercially available software) where the size of a crack at some time t₁ in the future, is a function of the initial crack size x₀ at the initial time t₀, and the fatigue loads applied over the time interval from t₀ to t₁. When a structure is first put into service, the size of the crack at t₀ is too small to know exactly, so it is characterized as a random variable. Uncertainty in the other input data, e.g., peak stress or model geometry, can also be characterized by random variables for each type of input. These random variables can be defined by a cumulative probability distribution function (cdf) as depicted in FIG. 2 where the height F(t₁) of the cdf curve at a point t₁ is the probability that the random variable T does not exceed t₁. Since the inputs to the physics model have uncertainty, then the output of the system (e.g., the crack size at some future time or the time to reach a critical crack size) has uncertainty and must also be represented by a random variable. In order to make predictions about the output, one must be able to compute the probability distribution that characterizes the randomness in the output quantity.

In one example, if X represents an input random vector to the physics model, and Y represents its output random variable, then the cumulative probability distribution of Y or its probability density function, which is the derivative of the cumulative probability distribution function, must be computed accurately in order to be able to make predictions about component failure, or to compute a maintenance schedule date. One approach to computing the output distribution is the Monte Carlo (MC) method. This method requires the generation of random values for the input variables X For each random value of X, the function implemented in the physics model is evaluated to produce a value for Y. The set of values for Y can then be grouped to give an approximation to the probability density function (pdf) or the cumulative distribution function (cdf) of Y. In practical applications, Y usually represents damage or time and is assumed to be non-negative.

The Monte Carlo method is used extensively and works with any number of input variables. However, it can be computationally expensive, and it is very difficult to get accurate results in the tails of the distribution due to the fact that the random samples occur in the tails infrequently due to the low probability of getting a value there. Additionally, if there are modifications or updates to the input probability distribution, then the entire sampling process must be done again. Therefore, it is desirable to have an alternative method for approximating the probability distribution of the output random variable Y.

### SUMMARY OF THE INVENTION

In one aspect, the invention provides a method including: receiving a plurality of values of an input variable representative of a physical characteristic of a component or system, using a physics model to produce an estimate of an output for each of the input values, mapping the output estimates to the input values to produce an output probability density or cumulative distribution function for the physical characteristic at a future time, and outputting the probability density or cumulative distribution function.

In another aspect, the invention provides an apparatus including a processor having an input for receiving an input probability distribution of a variable for a stochastic process, wherein the processor uses a mapping function, which relates outputs to inputs, to produce an exact representation of an output distribution for the stochastic process.

### BRIEF DESCRIPTION OF THE DRAWINGS

FIG. 1 is a schematic diagram of a system that can be used to implement an embodiment of the invention.

FIG. 2 is a graph that describes the cumulative distribution function of a random variable.

FIG. 3 is a graph wherein the cross-sections of the probability density for a stochastic process Y(t) have been plotted in the same plane that is used to describe Y(t).

FIGS. 4 through 9 are graphs that illustrate the steps of one embodiment of the invention.

FIG. 10 is a graph of the cumulative probability distribution of a physics model output for one or more inputs.

FIG. 11 is a graph illustrating a physics model function and its inverse at a fixed instant of time t.

FIG. 12 is a graph of the cumulative probability distribution of the random output of a physics model in terms of the input probability distribution and the mapping function.

FIG. 13 is a graph illustrating g(y,t), the approximate inverse function of a physics model.

FIG. 14 is a graph illustrating (g(y,t)), the approximation of the cumulative distribution function of a physics model using the input probability distribution and an approximation to the mapping function.

FIG. 15 is a graph computing the cumulative probability distribution function of the output of a physics model with several random inputs.

### DETAILED DESCRIPTION OF THE INVENTION

In one aspect, this invention provides an exact representation of the output distribution for a stochastic process in terms of an input probability distribution and a mapping function (which can be defined by a physics model) relating the output to the input. For the purposes of this description, a mapping function is described by an equation or procedure that relates the output of a physics model with its inputs. An example physics model is a software application that calculates the crack (defect) length as a function of time given inputs of an initial crack size, material parameters, and loads.

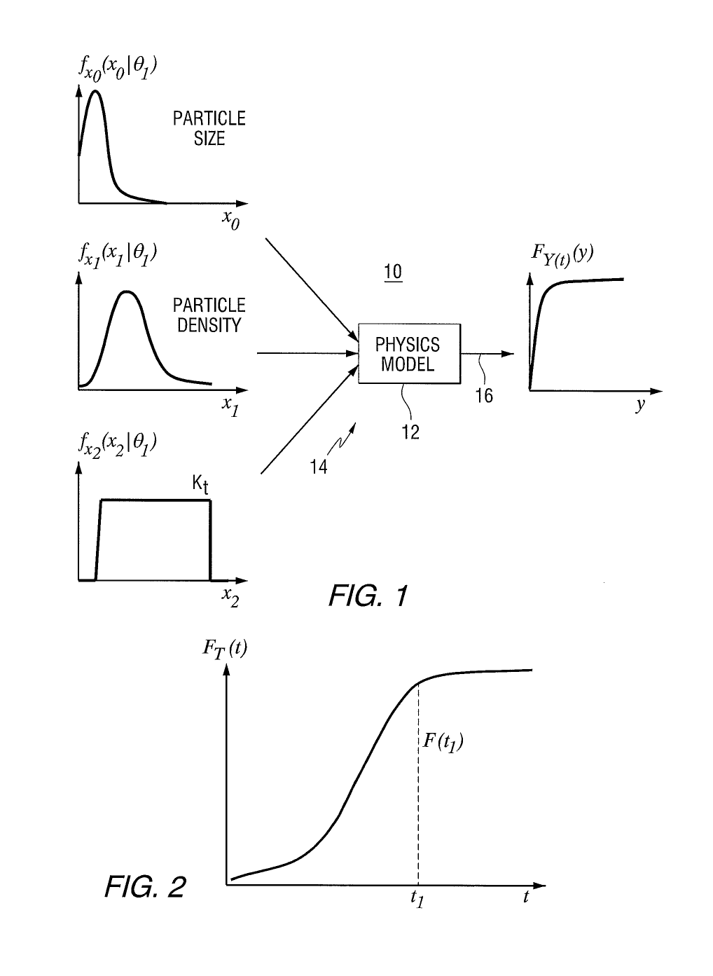

FIG. 1 is a schematic diagram of a system 10 that can be used to implement an embodiment of the invention. The system includes a processor 12 that includes one or more inputs 14 for receiving input data, which can be represented by one or more random variables, and an output 16 for delivering a computed result. The processor implements a physics model to calculated output values. The output values of the physics model are mapped to the input variables to produce a probability distribution function or a cumulative distribution function related to a physical characteristic represented by the input variables.

In FIG. 1, example input data are shown as physical characteristics of a component or system such as distributions of particle size, particle density, and the stress concentration factor, Kₜ. The processor can be, for example, a computer or other processor that is programmed or otherwise configured to receive a set of variables that are representative of a physical characteristic of a component or system and to process the variables as described below to produce an output. The processor can be programmed using a computer readable medium that contains instructions that are implemented by the processor to process the variables as described below to produce an output.

The input data can be represented as values of a random variable X. As an example, let X₁, X₂, . . . , X_{R} represent a set of one or more random variables whose values are input to a function (i.e., the physics model), and let Y represent its output random variable, then Y(t)=m(X₁, . . . , X_{R},t). The output in FIG. 1 is described by the stochastic process Y(t)=m(X,t) where m is a function that represents the model. For the purposes of this description, a physics model is a software module that computes the growth of a crack in a material over time. While this physics model can be utilized in an implementation of the invention, it should be understood that the invention is not limited to any particular physics model.

For a fixed time t, Y(t) is a random variable defined by its cumulative probability distribution (cdf) or its probability density (derivative of the cdf).

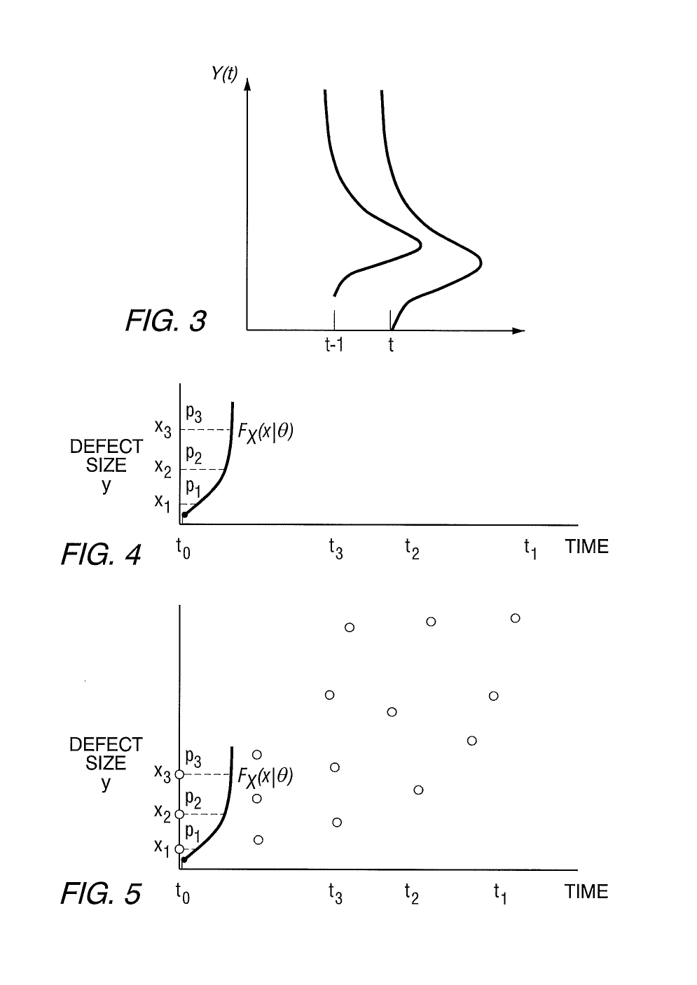

FIG. 3 is a graph wherein the cross-sections of the probability density of the stochastic process Y(t) have been plotted in the same plane.

For simplicity, assume there is a single random input (R=1). The method begins with input data including values xᵢ of a random variable X, which can represent a defect, such as an initial crack size. The input variables can represent the initial conditions or state of the material, which is needed by the physics model to be able to compute the output Y(t) over time. The output can describe the growth of the length of a crack in a material under load. The input variables are usually determined by experiments.

FIG. 4 is a graph of defect size versus time where the cumulative probability distribution Fx(x|θ) of the random X is illustrated and where pᵢ is the probability that the random variable X is at most xᵢ. Note the probability distribution Fx(x|θ) depends on the parameter θ, which can itself be a random variable. In that case the parameter θ is called a hyperparameter. To simplify the notation in the following discussion we will suppress the parameter θ.

Then the physics model function is used to produce an approximation or estimate of Y(t) by computing the defect values y(tⱼₖ, xₖ). For each random input xₖ the physics model computes points on each defect curve y(t, xₖ). This is illustrated in FIG. 5 where the circles represent computed y(tⱼₖ, xₖ) values at various times. Thus, FIG. 5 shows the size evolution of each starting point (t₀, x₁), (t₀, x₂), and (t₀, x₃) versus time as produced by the model.

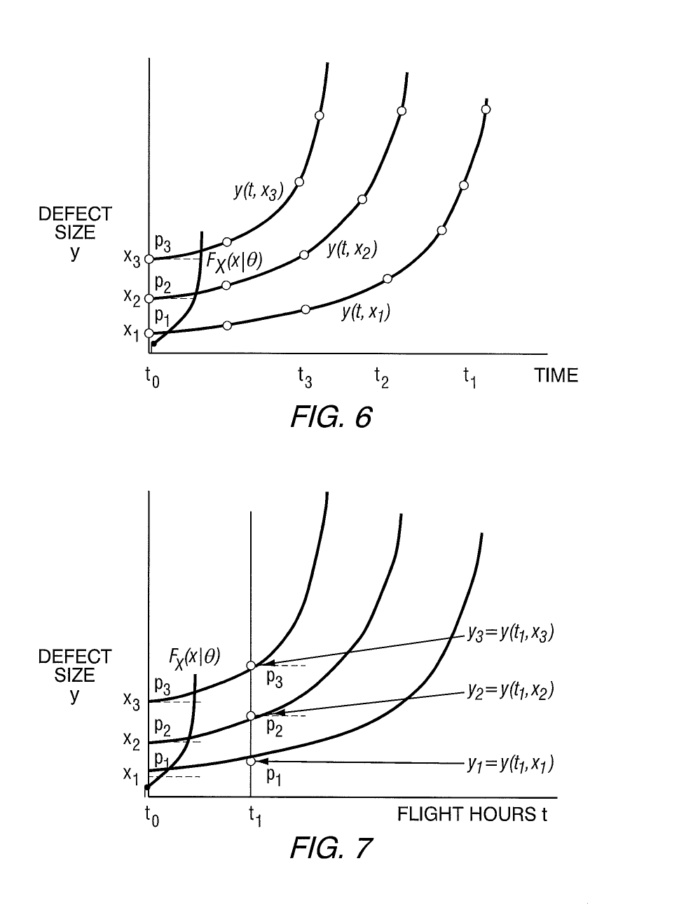

Next, the data (tⱼₖ, y(tⱼₖ,xₖ) is curve fitted, for example, with linear or cubic splines to generate curves y(t,xₖ), as shown in FIG. 6. The curve data (e.g., values defining a line or spline) are then stored for each associated start point xₖ. Alternatively, the data (tⱼₖ, y(tⱼₖ,xₖ) can be stored, and interpolation or curve fitting can be done from the stored data as needed. The splines in FIG. 6 represent equi-probable curves, which are described in detail in the following discussion.

Each spline is then intersected at a value t=t₁ by intersecting each curve with a vertical line, to generate values yₖ, where yₖ=y(t₁,xₖ) (this is called a vertical slice). This is illustrated in FIG. 7. If we wish to detect the probability that the crack size exceeds a critical defect size y_{d}, then the defect size y_{d} should lie within the minimum and maximum yₖ's.

To compute the cdf F_{Y}(y) at the vertical slice, t=t₁, F_{Y}(yₖ)=F_{X}(xₖ)=pₖ is computed. FIG. 7 shows how discrete probability values of the cumulative probability distribution, F_{Y}(y), of the random variable Y are computed from probability values defined by the input distribution F_{X}(x). In one embodiment, the present invention relates the probability of that outcome to the probability that such an initial crack size exists. In the simplest case, the probability pₖ represents the probability that the initial crack size is xₖ or smaller, and it is equal to the probability that the crack size at time t₁ is yₖ, or smaller. This assignment of probabilities is valid due to the Probability Distribution Mapping Method result which is derived in the following discussion (see equation (2)). Note that y represents the random crack size that Y(t) will reach at time t₁.

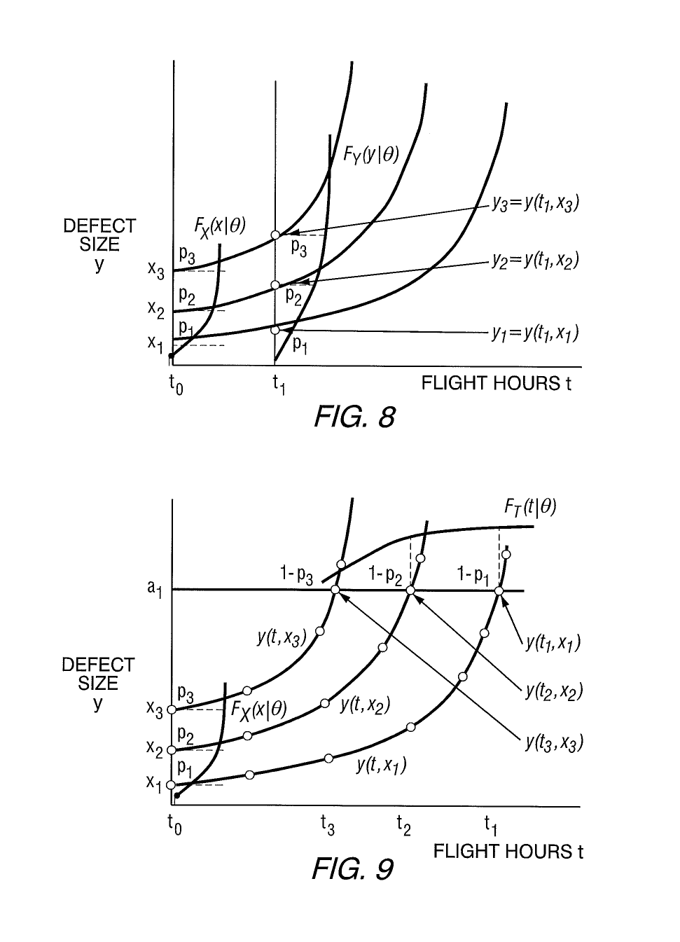

In FIG. 8 then, for any y, F_{Y}(y) is computed via interpolation. The interpolation procedure produces the smooth curve representing F_{Y}(y). In a similar manner in FIG. 9, each curve can be intersected by a horizontal line (i.e., horizontal slice, y=constant), then the cumulative probability distribution for the crack size is computed at a series of discrete values F_{T}(tₖ)=1−F_{X}(xₖ)=1−pₖ. Since initial crack sizes smaller than xₖ should fail later than tₖ, pₖ is also the probability that the failure will happen no sooner than tₖ. We are usually interested in whether the failure will happen at tₖ or sooner, which is 1−pₖ in this simple case. These probability values can then be interpolated to produce the final cumulative distribution F_{T}(t). The balance of this description shows how this idea can be generalized for multiple random inputs having more complex system model functions.

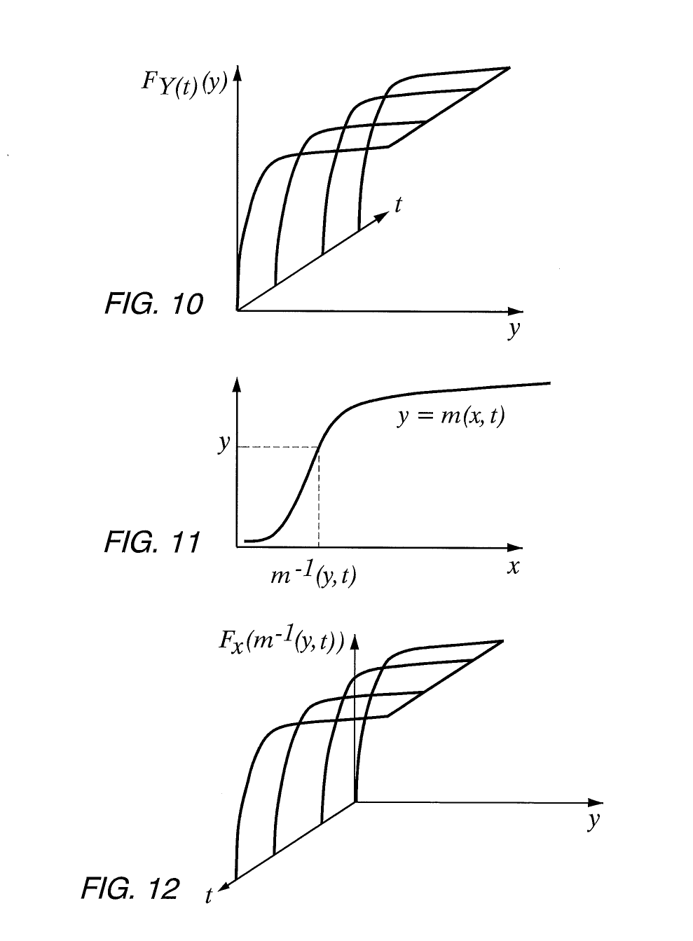

In a more detailed example, the cumulative distribution of Y(t), where Y(t) represents a generic output variable (not necessarily defect size) is defined by

$$\begin{matrix}{F}_{Y ( t )} ( y ) = P ( Y ( t ) \leq y ) = P ( m ( {X}_{1} , … {X}_{R} , t ) \leq y ) \\ = {\int \int }_{\{ {x}_{1} , … , {x}_{R} : m ( {x}_{1} , ... {x}_{R} , t ) \leq y \}} … \int f ( {x}_{1} , … {x}_{R} ) d {x}_{1} … d {x}_{R}\end{matrix} \qquad ( 1 )$$

where f(x₁, . . . , x_{R}) is the joint distribution of the input random variables. FIG. 10 is a graph of the cumulative distribution of the model output for one or more inputs.

If the inputs are independent, then f(x₁, . . . , x_{R})=f_{X}_{₁}(x₁) f_{X}_{₂}(x₂) . . . f_{X}_{_{R}}, (x_{R}). The integral is evaluated over the region defined by the set A(t,y)={x₁, . . . , x_{R}:m(x₁, . . . x_{R},t)≦y}.

For a one-dimensional input case, assume that there is only one input random variable (R=1) for the function Y(t)=m(X,t). From equation (1), if m(x,t) is an increasing function of x, then

$$\begin{matrix}{F}_{Y ( t )} ( y ) = P ( Y ( t ) \leq y ) = P ( m ( X , t ) \leq y ) \\ = {\int }_{\{ x : m ( x , t ) \leq y \}}^{ } {f}_{x} ( x ) d x \\ = P ( X \leq {m}^{- 1} ( y , t ) ) = {\int }_{- ∞}^{{m}^{- 1} ( y , t )} {f}_{x} ( x ) d x = {F}_{x} ( {m}^{- 1} ( y , t ) ) .\end{matrix}$$

If t=h(x,y) is a decreasing function of x, and T=h(X,y) then

F_{T(y)}(t)=P(T(y)≦t)=P(h(X,y)≦t)=P(X≧h⁻¹(t,y))=1−F_{X}(h⁻¹(t,y)).

The latter result corresponds to the horizontal slice case where T(y) represents the time to reach a crack of size y.

There are several possible ways to evaluate the cumulative distribution F_{Y(t)}(y). Either use the approach described above, illustrated in FIGS. 4-9, or evaluate the integral, or use the inverse function with the cumulative distribution for X Assume that the function m⁻¹(y,t), i.e., the inverse of the function m(x,t) exists for a fixed t. Note that it is well defined if m is an increasing function of x for a fixed t. In general the function m⁻¹(y,t) is only defined for a series of points, and the following discussion illustrates another procedure for computing the cumulative distribution F_{Y(t)}(y) as an alternative to the process discussed above. The former method evaluates the inverse function (the mapping function) at a series of points, then evaluates the cumulative distribution of the input random variable to compute the value of the output cumulative distribution at a sequence of values. Then these values can be interpolated to approximate the value of the output distribution at any point.

The following method takes the values of the inverse function at a series of points and interpolates them. Then the output cumulative distribution is approximated by the composite function of the input cumulative distribution as a function of the interpolated inverse function (see equation (2)). This discussion describes approximating the inverse function as a function of two variables (e.g., a surface approximation), however, one of the variables could be held fixed (e.g., a horizontal or vertical slice), for example, t could be held fixed, and a one-dimensional curve approximation of the inverse mapping could be calculated.

FIG. 11 shows an example of a physics model function and its inverse at one particular value. If the function y(t)=m(x,t) has an inverse, then the cdf of the output has a simple representation as shown in FIG. 12. This representation of the output cumulative distribution function is a composite function, i.e., a function of a function as is used in the definition of the log-normal distribution.

For the sake of completeness, we briefly describe the alternative method for obtaining the mapping function in terms of a surface approximation. In general, with this approach it can be more difficult to achieve a smooth approximation, and the previously described method using the horizontal and vertical slices of the crack growth curve would be preferable.

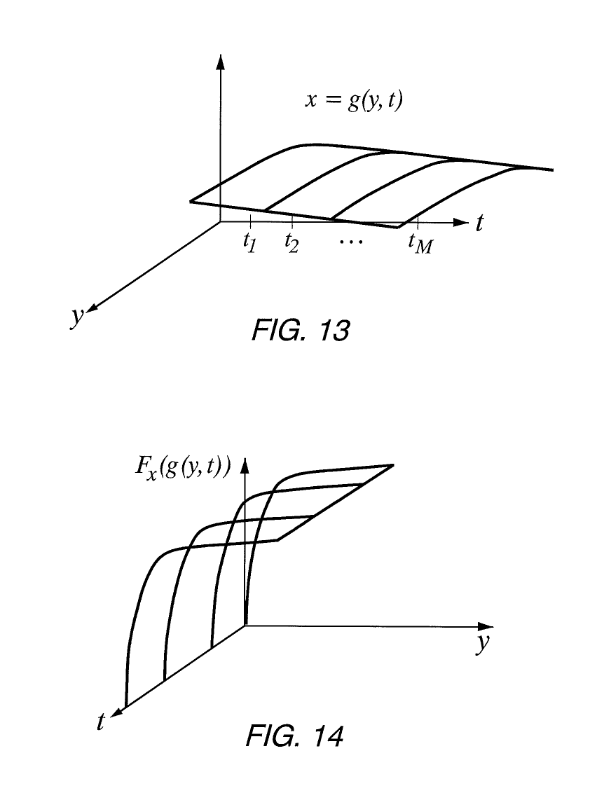

Usually there is no simple closed form expression for the inverse of the physics function m(x,t) even if m(x,t) is increasing in x for t fixed. Therefore, the inversion function must be approximated. Let yᵢⱼ=m(xᵢⱼ, tᵢ), j=1, . . . , Nᵢ, i=1, . . . , M, where Nᵢ and M are sufficiently large, then the function g(y,t) that fits the data xᵢⱼ=m⁻¹(yᵢⱼ,tᵢ), j=1, . . . , Nᵢ, i=1, . . . , M (interpolation or least squares) will be a good approximation to m⁻¹(y,t). FIG. 13 is a graph illustrating an example g(y,t).

Therefore,

F_{Y(t)}(y)=F_{X}(m⁻¹(y,t))≈F_{X}(g(y,t)) (2)

and the number of function evaluations needed to produce this approximation is much less than those needed for the Monte Carlo method. Note that the valid domain of y values for this approximation is equal to the domain of y values for which g(y,t) is defined. FIG. 14 is a graph illustrating the composite function Fₓ(g(y,t)), which is approximately equal to the output distribution F_{Y(t)}(y) (see equation (2)).

Let the characteristic function of a set A be defined by

$${I}_{A} ( x ) = \{ \begin{matrix}1 & x ∈ A \\ 0 & x ∉ A\end{matrix} .$$

Then equation (1) can be written as

$$\begin{matrix}{F}_{Y ( t )} ( y ) = \int \int … \int {I}_{A ( t , y )} ( {x}_{1} , … , {x}_{R} ) f ( {x}_{1} , … {x}_{R} ) d {x}_{1} … d {x}_{R} \\ = E ( {I}_{A ( t , y )} ( {X}_{1} , … , {X}_{R} ) ) \approx \frac{{\sum }_{j = 1}^{N} {I}_{A ( t , y )} ( {x}_{1 j} , … , {x}_{Rj} )}{N} .\end{matrix}$$

For the 1-dimensional case:

$$\begin{matrix}{F}_{Y ( t )} ( y ) = {\int }_{ }^{ } {I}_{A ( t , y )} ( x ) f ( x ) d x \\ = E ( {I}_{A ( t , y )} ( X ) ) \approx \frac{{\sum }_{j = 1}^{N} {I}_{A ( t , y )} ( {x}_{j} )}{N} .\end{matrix} \qquad ( 3 )$$

Equation (3) can be used to illustrate the limitations of the Monte Carlo (MC) method. A Monte Carlo simulation was executed with 1000 and with 5000 randomly sampled points for each value of y, t. At 1000 iterations the maximum difference between the exact cdf and the MC approximation was 0.045568, and occurred when (y, t)=(1.6, 3.2), and at 5000 iterations the maximum difference between the exact cdf and the MC approximation was 0.022007 and occurred when (y, t)=(0.95, 2.8). A million MC iterations (samples) over 5880 points gives an accuracy of 0.0005 and with a linear growth in central processing unit (cpu) time it takes 189,000 cpu seconds.

The method of this invention uses significantly fewer calculations than the Monte Carlo method, because it has an exact representation for the output probability distribution, which is used to compute values of the distribution. Furthermore, it does not require random samples of the input probability distribution (as Monte Carlo does) to produce the output probability distribution, therefore, the calculation for the probability at values in the tail of the distribution take no longer than at any other location. Finally, if there are changes or updates to the initial distribution(s) the Monte Carlo method must start over again, whereas the mapping function defined by this invention can still be used with the modified initial distribution(s).

The balance of this description shows how this idea can be generalized for multiple random inputs having more complex model functions. We will illustrate the multi-dimensional case by considering a simple example. Suppose we have a simple physics model that depends on two random inputs X₁ and X₂. Let the physics model of crack growth be defined by the equation Y(t)=e^{(X}^{₁}^{+x}^{₂}^{)t}. We wish to compute the cumulative distribution function (cdf) of the output, i.e., the crack size at time t:Y(t). We will determine the cdf by two different methods. The first method uses the following definition of the cdf:

$$\begin{matrix}{F}_{Y ( t )} ( y ) = P ( Y ( t ) \leq y ) = P ( {e}^{( {X}_{1} + {X}_{2} ) t} \leq y ) \\ = P ( ( {X}_{1} + {X}_{2} ) \leq ln ( y ) / t ) \\ = {\int }_{- ∞}^{\frac{lny}{t} \frac{lny}{t} - {x}_{2}} {\int }_{0}^{ } {f}_{{X}_{1} {X}_{2}} ( {x}_{1} , {x}_{2} ) d {x}_{1} d {x}_{2} .\end{matrix} \qquad ( 4 )$$

The last term is the double integral of the joint density function for the jointly distributed random variables X₁ and X₂. The upper limit,

$$\frac{ln y}{t}$$

on the outer integral is due to the fact that x₂ never exceeds this value, because x₁ is non-negative. The joint probability density function would be known for the inputs to the physics model and could be determined by statistical methods.

An alternative method for this simple example is to use the formula that specifies the joint density function of two random variables that are functions of two other random variables. In this example, the equations that define two variables y and y₂ in terms of the input variables x₁ and x₂ are

y=e^{(X}^{₁}^{+x}^{₂}⁾t

y₂=x₂ (5)

The first equation represents a physics model, and the second equation introduces an auxiliary variable y₂ which is just equal to x₂. The joint density for the variables y and y₂ can be expressed in terms of the joint density for x₁ and x₂:

$$\begin{matrix}{f}_{{YY}_{2}} ( y , {y}_{2} ) = \frac{{f}_{{X}_{1} {X}_{2}} ( {x}_{1} , {x}_{2} )}{\vert {te}^{( {x}_{1} + {x}_{2} ) t} \vert} \\ = \frac{{f}_{{X}_{1} {X}_{2}} ( - {y}_{2} + \frac{ln y}{t} , {y}_{2} )}{\vert ty \vert} .\end{matrix} \qquad ( 6 )$$

The denominator in equation (6) is the Jacobian of the transformation from the x₁ and x₂ to y and y₂. The variables x₁ and x₂ are functions of y and y₂ found by solving the system of equations (5) for x₁ and x₂ in terms of y and y₂, which is shown in the last term. To determine the cdf F_{Y(t)}(y), we must integrate equation (6) over y₂ to get the marginal probability density in y, then we must integrate the density to get the cdf since the density is the derivative of the cdf. Thus, we have

$$\begin{matrix}{F}_{Y ( t )} ( y ) = {\int }_{0}^{y} {f}_{Y} ( {y}^{′} ) d {y}^{′} \\ = {\int }_{0}^{y} {\int }_{- ∞}^{\frac{l n y}{t}} {f}_{{YY}_{2}} ( {y}^{′} , {y}_{2}^{′} ) d {y}_{2}^{′} d {y}^{′} \\ = {\int }_{0}^{y} {\int }_{- ∞}^{\frac{l n y}{t}} \frac{{f}_{{X}_{1} {X}_{2}} ( - {y}_{2}^{′} + \frac{ln {y}^{′}}{t} , {y}_{2}^{′} )}{\vert {ty}^{′} \vert} d {y}_{2}^{′} d {y}^{′} .\end{matrix}$$

The limit on the inner integral is not infinity, because y₂ never exceeds lny/t. If we now interchange the order of integration, we obtain

$${F}_{Y ( t )} ( y ) = {\int }_{- ∞}^{\frac{l n y}{t}} {\int }_{{e}^{{y}_{2}^{′} t}}^{y} \frac{{f}_{{X}_{1} {X}_{2}} ( - {y}_{2}^{′} + \frac{ln {y}^{′}}{t} , {y}_{2}^{′} )}{\vert {ty}^{′} \vert} d {y}^{′} d {y}_{2}^{′} .$$

Finally, we make a change of variables where we define

$${x}_{1} = - {y}_{2}^{′} + \frac{ln {y}^{′}}{t}$$

and we obtain

$${F}_{Y ( t )} ( y ) = {\int }_{- ∞}^{\frac{l n y}{t} - {y}_{2}^{′} + \frac{l n y}{t}} {\int }_{0}^{t} {f}_{{X}_{1} {X}_{2}} ( {x}_{1} , {y}_{2}^{′} ) d {x}_{1} d {y}_{2}^{′} .$$

If we replace the dummy variable y′₂ with x₂, we have the same expression as before (equation (4)). Either approach generalizes, and we will use the simpler, first approach for the general case of two or more random inputs to our physics model.

For a multi-dimensional input case, the physics model can be represented by the equation y=m(x₁, . . . , x_{R},t); therefore, the cdf of the output for random inputs is given by

F_{Y(t)}(y)=P(Y(t)≦y)=P(m(X₁,X₂, . . . , X_{R})≦y)=∫_{,(x}_{₁}_{, . . . , x}_{_{R}}_{,t)≦y} . . . ∫f(x₁, . . . , x_{R})dx₁ . . . ds_{R}.

To simplify the discussion, consider the case of two input random variables (R=2). Then

$$\begin{matrix}{F}_{Y ( t )} ( y ) = P ( m ( {X}_{1} , {X}_{2} , t ) \leq y ) \\ = {\int \int }_{m ( {X}_{1} , {X}_{2} , t ) \leq y} {f}_{{X}_{1} {X}_{2}} ( {x}_{1} , {x}_{2} ) d {x}_{1} d {x}_{2} .\end{matrix} \qquad ( 7 )$$

When integrating with respect to x₁ for the inner integral, we have x₂ fixed and t is fixed. Since y=m(x₁,x₂,t) is an increasing (or decreasing) function with respect to x₁, we have the limits on the inner integral range from 0 to the value of the inverse point x₁=m⁻¹(y,x₂,t) which we denote as x₁(y,x₂,t). The graph for this result is essentially the same as FIG. 11 except there is one more fixed variable x₂ in the equation. We now have

$$\begin{matrix}{F}_{Y ( t )} ( y ) = P ( m ( {X}_{1} , {X}_{2} , t ) \leq y ) \\ = {\int }_{- ∞}^{∞ {x}_{1} ( y , {x}_{2} , t )} {\int }_{0}^{ } {f}_{{X}_{1} {X}_{2}} ( {x}_{1} , {x}_{2} ) d {x}_{1} d {x}_{2} .\end{matrix} \qquad ( 8 )$$

The function x₁=x₁(y,x₂,t) represents the mapping function for this case of two random inputs. The infinite integral can be approximated by a finite integral since a value A(y,t) can be computed where the integrand is sufficiently small for values outside the interval (−A(y,t),A(y,t)).

If y or t is small, then integration must be performed over a sufficiently large interval, therefore, the limit may need to depend on y and t. Note that a Monte Carlo method can be used on the integral in equation (8) where a uniform sampling or quasi-random sequences can be used.

If the variables X₁, X₂ are independent, then equation (8) simplifies to

$$\begin{matrix}{F}_{Y ( t )} ( y ) = P ( m ( {X}_{1} , {X}_{2} , t ) \leq y ) \\ = {\int }_{- ∞}^{∞ {x}_{1} ( y , {x}_{2} , t )} {\int }_{0}^{ } {f}_{{X}_{1} {X}_{2}} ( {x}_{1} , {x}_{2} ) d {x}_{1} d {x}_{2} \\ = {\int }_{- ∞}^{∞ {x}_{1} ( y , {x}_{2} , t )} {\int }_{0}^{ } {f}_{{X}_{1}} ( {x}_{1} ) {f}_{{X}_{2}} ( {x}_{2} ) d {x}_{1} d {x}_{2} \\ = {\int }_{- ∞}^{∞} {F}_{{X}_{1}} ( {x}_{1} ( y , {x}_{2} , t ) ) {f}_{{X}_{2}} ( {x}_{2} ) d {x}_{2} .\end{matrix} \qquad ( 9 )$$

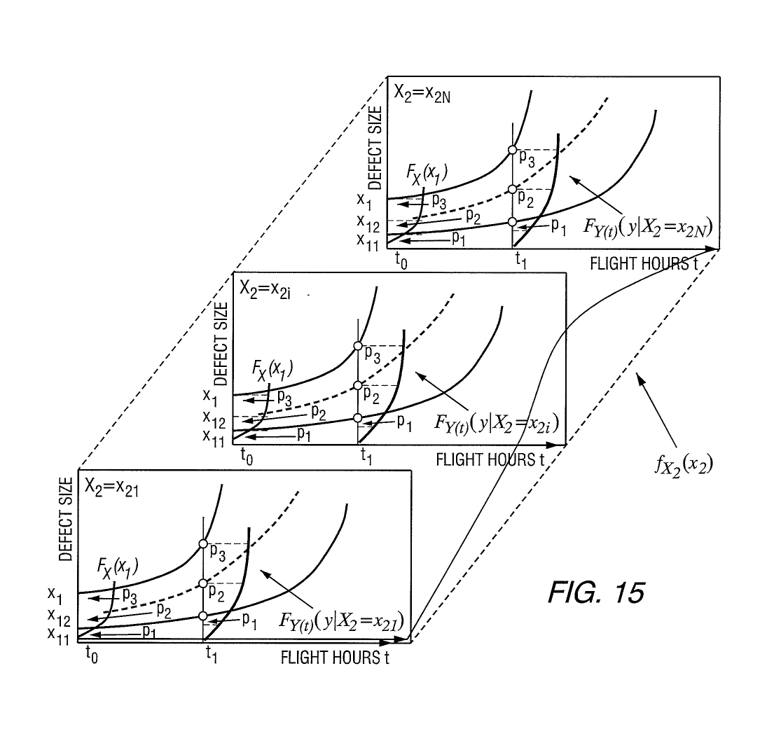

The computation of the cdf defined by equations (8) or (9) is similar to the description given for the case of one random input and illustrated in FIGS. 4-9. In this case of two random inputs, which we will assume are independent, the process for evaluating equation (9) can be understood as computing a sequence of cdfs, where the cdfs are defined by the term F_{X}, (x₁(y,x₂,t)) in the last expression in equation (9). Each cdf in the sequence is computed by fixing the value x₂ to a particular value for a discrete set of x₂ values. This is illustrated in FIG. 15. Since x₂ is fixed, we have a single random input and the vertical slice pdf at time t, F_{X}_{₁}(x₁(y,x₂,t)) is computed as in the single input case (i.e., FIGS. 4-9). Now each of these cdfs are multiplied by the probability density function for the second random input fₓ_{₂}, (x₂) and numerically integrated (fused) over all the sequence values for x₂ as defined by the last expression in equation (9).

In one aspect, the invention can be used to predict the occurrence of defects such as cracks in components of an aircraft. For example, the input data would be an initial crack size distribution, F_{X}(x) which represents a probability distribution of lengths of cracks determined from samples of measured cracks from a population of aircraft components.

A previously known physical model, such as, Fastran, which predicts crack growth would accept the input data and generate a plurality of estimated crack lengths at a plurality of future times for each of the input parameters. Thus, this physics model will produce a crack growth curve for each initial crack size input x, and this relationship between the output to the input of the model is represented by the equation y(t)=m(x,t) in the simple case of a single random input. With this relationship provided by the physics application we can define the mapping function and the desired probability distribution of the output (such as crack size) of the specific physics model.

Then these estimated crack lengths would be used in the process described above to determine the probability that a crack length would exceed a predetermined threshold at some future time. An operator can use the probability information to determine when the component should be replaced, or to determine the expected remaining life of the component.

While the invention has been described in terms of several embodiments, it will be apparent to those skilled in the art that various changes can be made to the described embodiments without departing from the scope of the invention as set forth in the following claims.

What is claimed is:

1. A method comprising:
receiving a plurality of values of an input variable representative of a physical characteristic of a component or system;
using a physics model to produce an estimate of an output for each of the input values;
mapping the output estimates to the input values to produce an output probability density or cumulative distribution function for the physical characteristic at a future time; and
outputting the probability density or cumulative distribution function.

2. The method of claim 1, wherein the physical characteristic comprises a crack length as a function of time or a time to failure as a function of crack length.

3. The method of claim 1, wherein the mapping step comprises:
fitting the estimates to a plurality of curves; and
using points on the curves to produce an output probability density for the physical characteristic at a future time.

4. The method of claim 3, wherein the step of using points on the curves to produce an output probability density for the physical characteristic at a future time selects values from corresponding points on the curves.

5. The method of claim 4, wherein the curves comprise one of:
a line or a spline.

6. The method of claim 4, wherein the curves are equi-probability curves.

7. The method of claim 4, further comprising:
taking a vertical slice of the curves.

8. The method of claim 7, further comprising:
computing the probability density or cumulative distribution function using points on the vertical slice.

9. The method of claim 1, wherein the probability density or cumulative distribution function is computed using interpolation.

10. The method of claim 1, wherein the input variables are random variables.

11. An apparatus comprising:
a processor having an input for receiving an input probability distribution of a variable for a stochastic process, wherein the processor uses a mapping function, which relates outputs to inputs, to produce an exact representation of an output distribution for the stochastic process.

12. The apparatus of claim 11, wherein the stochastic process represents a crack length as a function of time or a time to failure as a function of crack length.

13. The apparatus of claim 11, wherein the processor fits estimates to a plurality of curves and uses points on the curves to produce the output distribution.

14. The apparatus of claim 13, wherein the processor selects values from corresponding points on the curves.

15. The apparatus of claim 14, wherein the curves comprise one of:
a line or a spline.

16. The apparatus of claim 15, wherein the curves are equi-probability curves.

17. The apparatus of claim 15, wherein the processor takes a vertical slice of the curves.

18. The apparatus of claim 17, wherein the output distribution is computed using points on the vertical slice.

19. The apparatus of claim 11, wherein the output distribution is computed using interpolation.

20. The apparatus of claim 11, wherein the processor receives random input variables.
